(19) United States
(12) Patent Application Publication
(10) Pub. No.: US 2025/0323356 A1
(43) Pub. Date: Oct. 16, 2025

(54) BATTERY CELL, SECONDARY BATTERY, AND ELECTRIC DEVICE

(71) Applicants: Xiamen Ampace Technology Limited, Xiamen (CN); Ningde Amperex Technology Limited, Ningde (CN)

(72) Inventors: Feilong GUO, Ningde (CN); Hu LI, Ningde (CN); Jianjun WANG, Ningde (CN); Jinhua HE, Ningde (CN)

(73) Assignees: Xiamen Ampace Technology Limited, Xiamen (CN); Ningde Amperex Technology Limited, Ningde (CN)

(21) Appl. No.: 19/249,182

(22) Filed: Jun. 25, 2025

Related U.S. Application Data
(63) Continuation of application No. PCT/CN2022/142042, filed on Dec. 26, 2022.

(51) Int. Cl. H01M 50/133; H01M 50/105; H01M 50/119; H01M 50/121; H01M 50/124; H01M 50/178; H01M 50/193

(52) U.S. Cl. CPC H01M 50/133; H01M 50/105; H01M 50/119; H01M 50/121; H01M 50/124; H01M 50/178; H01M 50/193

(57) ABSTRACT

A battery cell includes an electrode assembly, a packaging bag, and a first tab lead. The packaging bag includes a first packaging film and a second packaging film. An end of the first tab lead is connected to an end of the first tab of the electrode assembly to form a first connection portion, and another end of the first tab lead extends out of the packaging bag. A first groove and a second groove are formed on a side of the first packaging film facing the second packaging film; at least a portion of the body portion of the electrode assembly is accommodated in the first groove; and at least a portion of the first connection portion is accommodated in the second groove.

### CROSS-REFERENCE TO RELATED APPLICATIONS

This application is a continuation application of International Application No. PCT/CN2022/142042, filed on Dec. 26, 2022, the contents of which is incorporated herein by reference in its entirety.

### TECHNICAL FIELD

This application relates to the field of battery technologies, and specifically, to a battery cell, a secondary battery, and an electric device.

### BACKGROUND

With the development of new energy technologies, battery cells, due to their high energy density and high degree of customization, are widely used in portable electronic devices, electric transportation tools, electric tools, drones, energy storage devices, and other fields. With increasingly high requirements for the charging and discharging rates of the battery cells, the challenges faced in packaging of the battery cells are also increasing, and packaging reliability is the basis for the service life and lifespan of the battery cells. In related technologies, top sealing positions of battery cells (especially large battery cells) have problems of being uneven and prone to wrinkling during the packaging process (due to factors such as extrusion stress). Therefore, how the packaging reliability of batteries is improved becomes an urgent problem to be solved by persons skilled in the art.

### SUMMARY

Some embodiments of this application provide a battery cell, a secondary battery, and an electric device to improve the packaging reliability of the battery cell.

According to a first aspect, some embodiments of this application provide a battery cell. The battery cell includes an electrode assembly, a packaging bag, and a first tab lead. The electrode assembly includes a body portion and a first tab, where an end of the first tab is connected to the body portion. The packaging bag includes a first packaging film and a second packaging film, and the electrode assembly is disposed between the first packaging film and the second packaging film. An end of the first tab lead is connected to another end of the first tab to form a first connection portion, and another end of the first tab lead extends out of the packaging bag from between the first packaging film and the second packaging film. A first groove and a second groove are formed on a side of the first packaging film facing the second packaging film; at least a portion of the body portion is accommodated in the first groove; and at least a portion of the first connection portion is accommodated in the second groove.

In the above technical solution, since the second groove is formed on the side of the first packaging film facing the second packaging film, at least a portion of the first connection portion formed by connecting the first tab and the first tab lead is accommodated in the second groove. This may reduce the risks of interference between the first connection portion and the first packaging film as well as interference between the first connection portion and the second packaging film, reducing the extrusion stress between the first connection portion and the first packaging film as well as the extrusion stress between the first connection portion and the second packaging film, thereby alleviating the problem of the first packaging film and the second packaging film being uneven and prone to wrinkling at top sealing positions due to the extrusion stress during the packaging of the battery cell, and improving the packaging reliability.

In some embodiments of the first aspect of this application, a depth of the second groove is less than a depth of the first groove, which may improve the packaging stability of the battery cell.

In the above technical solution, along the depth direction of the first groove and the second groove, a dimension of the body portion is greater than a dimension of the first connection portion, and the depth of the second groove is less than the depth of the first groove. In the depth direction of the second groove, a space defined by the second groove and the second packaging film is more compatible with the dimension of the first connection portion. This further reduces the risks of interference between the first connection portion and the first packaging film as well as interference between the first connection portion and the second packaging film, reducing the risk of the first packaging film and the second packaging film being uneven at the top sealing positions due to the extrusion stress during the packaging of the battery cell, thereby effectively alleviating the problem of the packaging bag having wrinkles during the packaging of the battery cell, further improving the packaging reliability.

In some embodiments of the first aspect of this application, a side surface of the first groove and a bottom surface of the second groove are connected to each other through a first arc surface; and a radius of the first arc surface is R₁, where 0.3 mm≤R₁≤5 mm.

In the above technical solution, the side surface of the first groove and the bottom surface of the second groove are connected to each other through the first arc surface, which may reduce the first packaging film from having stress concentration between the side surface of the first groove and the bottom surface of the second groove, thereby improving the strength of the first packaging film. If the radius R₁ of the first arc surface is less than 0.3 mm, the stress concentration factor of the first packaging film between the side surface of the first groove and the bottom surface of the second groove is not significantly reduced, failing to effectively alleviate the stress concentration problem between the side surface of the first groove and the bottom surface of the second groove. If the radius R₁ of the first arc surface is greater than 5 mm, a wall thickness at a corresponding position of the first arc surface may be excessively small, thus reducing the structural strength of the first packaging film. Therefore, the radius R₁ of the first arc surface satisfying 0.3 mm≤R₁≤5 mm may reduce stress concentration between the side surface of the first groove and the bottom surface of the second groove while ensuring the wall thickness of the first packaging film at the corresponding position of the first arc surface to satisfy the strength requirements of the first packaging film.

In some embodiments of the first aspect of this application, along a thickness direction of the battery cell, a projection of the first connection portion on the first packaging film falls within the second groove.

In the above technical solution, along the thickness direction of the battery cell, the projection of the first connection portion on the first packaging film falls within the second groove, so that in directions other than the thickness direction of the battery cell, the first connection portion does not extend out of the second groove. This further reduces the risks of interference between the first connection portion and the first packaging film as well as interference between the first connection portion and the second packaging film, reducing the risk of the first packaging film and the second packaging film being uneven and prone to wrinkling at the top sealing positions due to the extrusion stress during the packaging of the battery cell, thereby effectively alleviating the problem of the packaging bag having wrinkles during the packaging of the battery cell, further improving the packaging reliability.

In some embodiments of the first aspect of this application, along a length direction of the battery cell, a length of the second groove is L₁, and a length of the first connection portion is L₂; where 0.2 mm≤L₁−L₂≤5 mm.

In the above technical solution, if L₁−L₂<0.2 mm, along the length direction of the battery cell, a margin of the length of the second groove relative to the length of the first connection portion is small, which is not conducive to accommodating the first connection portion in the second groove during the assembly of the battery cell. If L₁−L₂>5 mm, a large space in the second groove is wasted, making the first connection portion be prone to shaking in the second groove, thus increasing the packaging difficulty of the battery cell. Therefore, 0.2 mm≤L₁−L₂≤5 mm allows the length of the second groove to have a reasonable margin relative to the length of the first connection portion, is conducive to accommodating the first connection portion in the second groove, and may also reduce the space waste, reduce the degree of shaking of the first connection portion in the second groove, and reduce the packaging difficulty of the battery cell.

In some embodiments of the first aspect of this application, along the thickness direction of the battery cell, a vertical distance from the bottom surface of the second groove to an inner surface of the second packaging film is T₁, and a maximum thickness of the first connection portion is T₂; where 1≤T₁/T₂≤2.

In the above technical solution, if T₁/T₂<1, along the thickness direction of the battery cell, a space between the bottom surface of the second groove and the inner surface of the second packaging film is less than the maximum thickness of the first connection portion, leading to interference between the first connection portion and the first packaging film as well as interference between the first connection portion and the second packaging film, and making it difficult to accommodate the first connection portion between the first packaging film and the second packaging film. If T₁/T₂>2, the space between the bottom surface of the second groove and the inner surface of the second packaging film is excessively large relative to the maximum thickness of the first connection portion, making the first connection portion be prone to shaking between the first packaging film and the second packaging film along the thickness direction of the battery cell. Therefore, 1≤T₁/T₂≤2 may make the first connection portion be smoothly accommodated between the first packaging film and the second packaging film, and may also alleviate the problem of the first connection portion shaking between the first packaging film and the second packaging film along the thickness direction of the battery cell.

In some embodiments of the first aspect of this application, along a width direction of the battery cell, a width of the second groove is W₁, and a width of the first connection portion is W₂; where 0.2 mm≤W₁−W₂≤10 mm.

In the above technical solution, if W₁−W₂<0.2 mm, along the width direction of the battery cell, a margin of the width of the second groove relative to the width of the first connection portion is small, which is not conducive to accommodating the first connection portion in the second groove during the assembly of the battery cell. If W₁−W₂>10 mm, a large space in the second groove is wasted, making the first connection portion be prone to shaking in the second groove, thus increasing the packaging difficulty of the battery cell. Therefore, 0.2 mm≤W₁−W₂≤10 mm allows the width of the second groove to have a reasonable margin relative to the width of the first connection portion, is conducive to accommodating the first connection portion in the second groove, and may also reduce the space waste, reduce the degree of shaking of the first connection portion in the second groove, and reduce the packaging difficulty of the battery cell.

In some embodiments of the first aspect of this application, along the length direction of the battery cell, a length of the first groove is L₃, and a length of the body portion is L₄; where 0.2 mm≤L₃−L₄≤10 mm; and/or along the width direction of the battery cell, a width of the first groove is W₃, and a width of the body portion is W₄; where 0.2 mm≤W₃−W₄≤3 mm.

In the above technical solution, if L₃−L₄<0.2 mm, along the length direction of the battery cell, a margin of the length of the first groove relative to the length of the body portion is small, which is not conducive to accommodating the body portion in the first groove during the assembly of the battery cell. If L₃−L₄>10 mm, a large space in the first groove is wasted, making the body portion be prone to shaking in the first groove. Therefore, 0.2 mm≤L₃−L₄≤10 mm allows the length of the first groove to have a reasonable margin relative to the length of the body portion, is conducive to accommodating the body portion in the first groove, and may also reduce the space waste and reduce the degree of shaking of the body portion in the first groove. If W₃−W₄<0.2 mm, along the width direction of the battery cell, a margin of the width of the first groove relative to the width of the body portion is small, which is not conducive to accommodating the body portion in the first groove during the assembly of the battery cell. If L₁−L₂>3 mm, a large space in the first groove is wasted, making the body portion be prone to shaking in the first groove along the width direction of the battery cell. Therefore, 0.2 mm≤W₃−W₄≤3 mm allows the width of the first groove to have a reasonable margin relative to the width of the body portion, is conducive to accommodating the body portion in the second groove, and may also reduce the space waste and reduce the degree of shaking of the body portion in the first groove along the width direction of the battery cell.

In some embodiments of the first aspect of this application, a side of the second packaging film facing the first packaging film is a plane. This plane may refer to an absolute plane or a plane with manufacturing errors.

In the above technical solution, a surface of the second packaging film facing the first packaging film is a plane, allowing the structure of the second packaging film to be simple, thereby facilitating the manufacturing and formation of the packaging bag.

In some embodiments of the first aspect of this application, a third groove is formed on the side of the second packaging film facing the first packaging film; the third groove is opposite to the first groove; and the body portion is accommodated in a space enclosed by the first groove and the third groove.

In the above technical solution, the third groove opposite to the first groove is formed on the surface of the second packaging film facing the first packaging film. The first groove and the second groove jointly enclose a space for accommodating the body portion, so that the space for accommodating the body portion is distributed to the first packaging film and the second packaging film. As compared with a case where the first groove is only formed on the first packaging film, the first groove is formed on the first packaging film and the third groove is formed on the second packaging film, making the depth of each groove for accommodating the body portion be smaller, thereby making the formation difficulty of the packaging bag be lower.

In some embodiments of the first aspect of this application, along the thickness direction of the battery cell, a depth of the first groove is M₁, a depth of the third groove is M₃, and a thickness of the body portion is M₄; where 1≤(M₁+M₃)/M₄≤1.3.

In the above technical solution, if (M₁+M₃)/M₄<1, along the thickness direction of the battery cell, a space between a bottom surface of the first groove and a bottom surface of the third groove may be less than the thickness of the body portion, causing the body portion to interfere with the first packaging film and the second packaging film, and making it difficult to accommodate the body portion between the first packaging film and the second packaging film. If (M₁+M₃)/M₄>1.3, the space between the bottom surface of the first groove and the bottom surface of the third groove is excessively large relative to the thickness of the body portion, making the body portion be prone to shaking between the first packaging film and the second packaging film along the thickness direction of the battery cell. Therefore, 1≤(M₁+M₃)/M₄≤1.3 may make the body portion be smoothly accommodated between the first packaging film and the second packaging film, and may also reduce the degree of shaking of the body portion between the first packaging film and the second packaging film along the thickness direction of the battery cell.

In some embodiments of the first aspect of this application, a fourth groove is further formed on the side of the second packaging film facing the first packaging film; the fourth groove is opposite to the second groove; at least a portion of the first connection portion is accommodated in a space enclosed by the second groove and the fourth groove; and a depth of the fourth groove is less than a depth of the third groove.

In the above technical solution, the fourth groove opposite to the second groove is formed on the surface of the second packaging film facing the first packaging film. The second groove and the fourth groove jointly enclose a space for accommodating the first connection portion, so that the space for accommodating the first connection portion is distributed to the first packaging film and the second packaging film. As compared with a case where the second groove is only formed on the first packaging film, the second groove is formed on the first packaging film and the fourth groove is formed on the second packaging film, making the depth of each groove for accommodating the first connection portion be smaller, thereby making the formation difficulty of the packaging bag be lower.

In some embodiments of the first aspect of this application, along the thickness direction of the battery cell, a depth of the second groove is M₂, a depth of the fourth groove is M₅, and a maximum thickness of the first connection portion is T₂; where 1≤(M₂+M₅)/T₂≤2.

In the above technical solution, if (M₂+M₅)/T₂<1, along the thickness direction of the battery cell, a space between a bottom surface of the second groove and a bottom surface of the fourth groove may be less than the maximum thickness of the first connection portion, causing the first connection portion to interfere with the first packaging film and the second packaging film, and making it difficult to accommodate the first connection portion between the first packaging film and the second packaging film. If (M₂+M₅)/T₂>2, the space between the bottom surface of the second groove and the bottom surface of the fourth groove is excessively large relative to the maximum thickness of the first connection portion, making the first connection portion be prone to shaking between the first packaging film and the second packaging film along the thickness direction of the battery cell. Therefore, 1≤(M₂+M₅)/T₂≤2 may make the body portion be smoothly accommodated between the first packaging film and the second packaging film, and may also reduce the degree of shaking of the body portion between the first packaging film and the second packaging film along the thickness direction of the battery cell.

In some embodiments of the first aspect of this application, the electrode assembly further includes a second tab, the second tab and the first tab have opposite polarities, and an end of the second tab is connected to the body portion. The battery cell further includes a second tab lead, where an end of the second tab lead is connected to another end of the second tab to form a second connection portion, and another end of the second tab lead extends out of the packaging bag from between the first packaging film and the second packaging film. At least a portion of the second connection portion is accommodated in the second groove.

In the above technical solution, at least a portion of the second connection portion formed by connecting the second tab and the second tab lead is accommodated in the second groove. This may reduce the risks of interference between the second connection portion and the first packaging film as well as interference between the second connection portion and the second packaging film, reducing the risk of the first packaging film and the second packaging film being uneven at positions corresponding to the second connection portion due to the stress during the packaging of the battery cell, thereby effectively alleviating the problem of the packaging bag having wrinkles during the packaging of the battery cell, improving the packaging reliability, and causing no reduction of the energy density of the battery cell. The second connection portion and the first connection portion are both accommodated in the second groove, resulting in fewer grooves on the packaging bag, allowing the structure of the packaging bag to be simpler, thereby facilitating the manufacturing and formation of the packaging bag.

In some embodiments of the first aspect of this application, the electrode assembly further includes a second tab, the second tab and the first tab have opposite polarities, and an end of the second tab is connected to the body portion. The battery cell further includes a second tab lead, where an end of the second tab lead is connected to another end of the second tab to form a second connection portion, and another end of the second tab lead extends out of the packaging bag from between the first packaging film and the second packaging film. A fifth groove is further formed on the side of the first packaging film facing the second packaging film; at least a portion of the second connection portion is accommodated in the fifth groove; and a depth of the fifth groove is less than the depth of the first groove.

In the above technical solution, at least a portion of the second connection portion formed by connecting the second tab and the second tab lead is accommodated in the fifth groove. This may reduce the risks of interference between the second connection portion and the first packaging film as well as interference between the second connection portion and the second packaging film, reducing the risk of the first packaging film and the second packaging film being uneven at positions corresponding to the second connection portion due to the stress during the packaging of the battery cell, thereby effectively alleviating the problem of the packaging bag having wrinkles during the packaging of the battery cell, improving the packaging reliability, and causing no reduction of the energy density of the battery cell. The second connection portion and the first connection portion are respectively accommodated in the fifth groove and the second groove, which may reduce the risks of short circuits in the battery cell and facilitate the independent packaging of the battery cell at positions corresponding to the first connection portion and the second connection portion.

According to a second aspect, some embodiments of this application provide a secondary battery including the battery cell provided in these embodiments of the first aspect.

In the above technical solution, the battery cell provided in these embodiments of the first aspect of this application has a lower possibility of the packaging bag having wrinkles during the packaging process, so that the packaging reliability is improved. Therefore, the secondary battery including the battery cell has high packaging reliability, thereby allowing the secondary battery to have good safety performance.

According to a third aspect, some embodiments of this application provide an electric device including the secondary battery provided in these embodiments of the second aspect.

In the above technical solution, the secondary battery provided in these embodiments of the second aspect has good safety performance and may improve the electric safety of the electric device.

### BRIEF DESCRIPTION OF DRAWINGS

To describe the technical solutions in some embodiments of this application more clearly, the following briefly describes the accompanying drawings required for describing some embodiments. It is appreciated that the accompanying drawings below show merely some embodiments of this application and thus should not be considered as limitations on the scope. Persons of ordinary skill in the art may still derive other related drawings from the accompanying drawings without creative efforts.

FIG. 1 is a cross-sectional view of a battery cell according to some embodiments of this application;

FIG. 2 is a cross-sectional view along direction A-A of the battery cell in FIG. 1;

FIG. 3 is a schematic structural diagram of a packaging bag after unfolded according to some embodiments of this application;

FIG. 4 is a cross-sectional view along direction B-B of the packaging bag in FIG. 3;

FIG. 5 is a cross-sectional view of a battery cell according to some other embodiments of this application;

FIG. 6 is a schematic structural diagram of a packaging bag according to some other embodiments of this application;

FIG. 7 is a schematic structural diagram of the packaging bag after unfolded in FIG. 6;

FIG. 8 is a cross-sectional view along direction C-C in FIG. 7;

FIG. 9 is a cross-sectional view of a battery cell according to still some other embodiments of this application;

FIG. 10 is a schematic structural diagram of a packaging bag according to still some other embodiments of this application;

FIG. 11 is a schematic structural diagram of the packaging bag after unfolded in FIG. 10;

FIG. 12 is a cross-sectional view along direction D-D in FIG. 11;

FIG. 13 is a schematic structural diagram of a packaging bag according to still some other embodiments of this application;

FIG. 14 is a schematic structural diagram of a packaging bag according to still some other embodiments of this application;

FIG. 15 is a schematic structural diagram of a battery cell according to still some other embodiments of this application;

FIG. 16 is a schematic structural diagram of the packaging bag after unfolded in FIG. 15;

FIG. 17 is a cross-sectional view along direction E-E in FIG. 16;

FIG. 18 is a schematic structural diagram of a packaging bag after unfolded according to still some other embodiments of this application;

FIG. 19 is a schematic structural diagram of a packaging bag after unfolded according to still some other embodiments of this application;

FIG. 20 is a schematic structural diagram of a packaging bag after unfolded according to still some other embodiments of this application;

FIG. 21 is a schematic structural diagram of a packaging bag after unfolded according to still some other embodiments of this application;

FIG. 22 is a schematic structural diagram of a packaging bag after unfolded according to still some other embodiments of this application; and

FIG. 23 is a schematic structural diagram of a packaging bag after unfolded according to still some other embodiments of this application.

Reference signs: 100. battery cell; 10. electrode assembly; 11. body portion; 12. first tab; 13. second tab; 20. packaging bag; 21. first packaging film; 211. first groove; 212. second groove; 213. first surface; 214. first arc surface; 215. fifth groove; 22. second packaging film; 221. second surface; 222. third groove; 223. fourth groove; 224. second arc surface; 225. sixth groove; 23. folding portion; 30′. tab lead; 30. first tab lead; 40′. connection portion; 40. first connection portion; 50. second tab lead; 60. second connection portion; X. thickness direction of battery cell; Y. length direction of battery cell; and Z. width direction of battery cell.

### DETAILED DESCRIPTION

To make the objectives, technical solutions, and advantages in some embodiments of this application clearer, the following clearly and completely describes the technical solutions in some embodiments of this application with reference to the accompanying drawings in some embodiments of this application. Apparently, the described embodiments are some but not all of these embodiments of this application. Generally, the components in some embodiments of this application as described and illustrated in the accompanying drawings herein may be arranged and designed in a variety of configurations.

Therefore, the following detailed description of some embodiments of this application as provided in the accompanying drawings is not intended to limit the protection scope of this application but merely to represent selected embodiments of this application. All other embodiments obtained by persons of ordinary skill in the art based on some embodiments of this application without creative efforts shall fall within the protection scope of this application.

It should be noted that, without conflict, some embodiments and features in these embodiments in this application may be combined with each other.

In addition, the terms “first”, “second”, “third”, and the like are merely intended for distinguishing purposes and shall not be understood as any indication or implication of relative importance.

Currently, from the perspective of market development, the application of secondary batteries is becoming more extensive. Secondary batteries have been widely used in many fields including electric transportation tools such as electric bicycles, electric motorcycles, and electric vehicles, electric tools, drones, and energy storage devices. With the continuous expansion of application fields of secondary batteries, market demands for secondary batteries are also increasing.

Based on the problems existing in the background, to alleviate the problem of unreliable packaging caused by interference or extrusion stress during a packaging process of a packaging bag, some embodiments of this application provide a battery cell. A side of a first packaging film facing a second packaging film is provided with a first groove and a second groove. A body portion of an electrode assembly is accommodated in the first groove. At least a portion of a connection portion formed by connecting a tab and a tab lead is accommodated in the second groove.

Since the second groove for accommodating at least a portion of the connection portion is formed on the side of the first packaging film facing the second packaging film before packaging, as compared with a case where the second groove is formed during the packaging process, this may the risks of interference between the connection portion and the first packaging film as well as interference between the connection portion and the second packaging film, reducing the extrusion stress between the connection portion and the first packaging film as well as the extrusion stress between the connection portion and the second packaging film, thereby alleviating the problem of the first packaging film and the second packaging film being uneven and prone to wrinkling at top sealing positions due to the extrusion stress during packaging of the battery cell, and improving the packaging reliability.

The battery cell disclosed in these embodiments of this application may be used without limitation in electric devices such as an electric two-wheeler, an electric tool, a drone, and an energy storage device. A battery with an operation condition in this application may be used as a power system for an electric device, which is conducive to reducing the overall size of the battery and increasing the energy density of the power system.

Some embodiments of this application provide an electric device using a battery as a power source. The electric device may be but is not limited to an electronic device, an electric tool, an electric transportation tool, a drone, or an energy storage device. The electronic device may include a mobile phone, a tablet computer, a notebook computer, and the like. The electric tool may include an electric drill, an electric saw, and the like. The electric transportation tool may include an electric vehicle, an electric motorcycle, an electric bicycle, and the like.

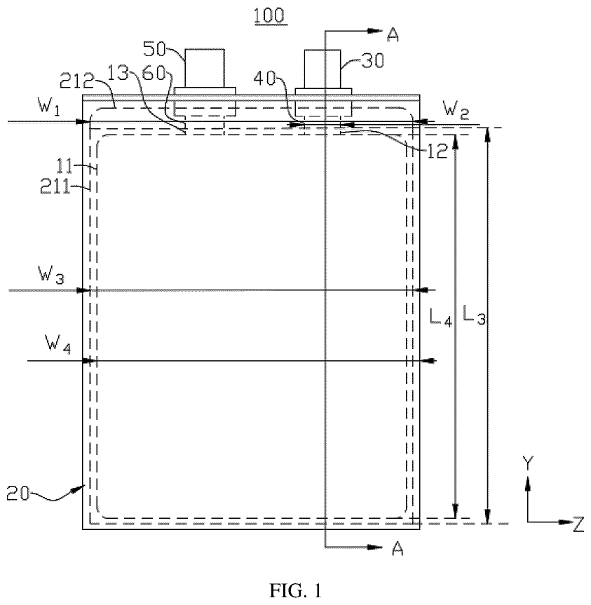

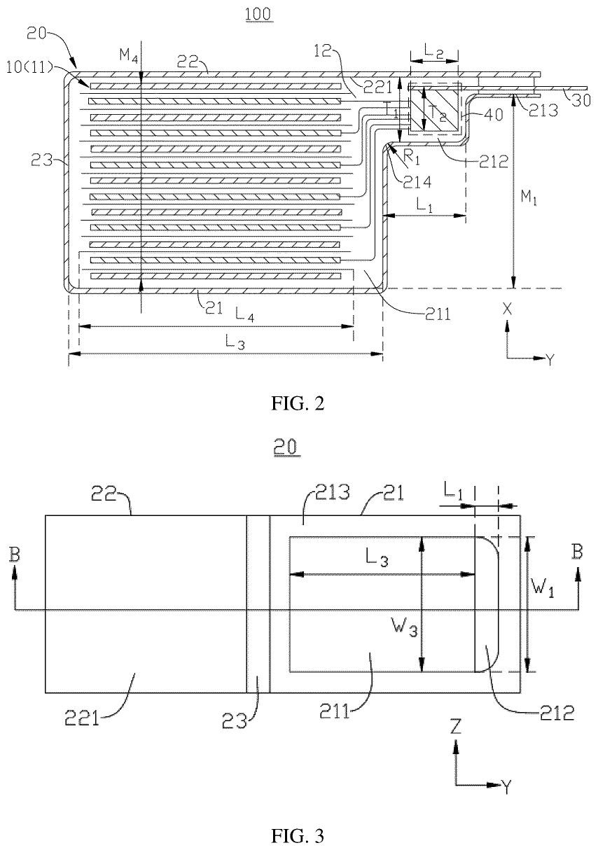

As shown in FIGS. 1 and 2, some embodiments of this application provide a battery cell 100. The battery cell 100 includes an electrode assembly 10, a packaging bag 20, and a first tab lead 30. The electrode assembly 10 includes a body portion 11 and a first tab 12, where an end of the first tab 12 is connected to the body portion 11. The packaging bag 20 includes a first packaging film 21 and a second packaging film 22, and the electrode assembly 10 is disposed between the first packaging film 21 and the second packaging film 22. An end of the first tab lead 30 is connected to another end of the first tab 12 to form a first connection portion 40, and another end of the first tab lead 30 extends out of the packaging bag 20 from between the first packaging film 21 and the second packaging film 22. A first groove 211 and a second groove 212 are formed on a side of the first packaging film 21 facing the second packaging film 22; at least a portion of the body portion 11 is accommodated in the first groove 211; and at least a portion of the first connection portion 40 is accommodated in the second groove 212.

The electrode assembly 10 includes a positive electrode plate (not shown in the figure), a negative electrode plate (not shown in the figure), and a separator (not shown in the figure). Operation of the battery cell 100 mainly relies on migration of metal ions between the positive electrode plate and the negative electrode plate. The positive electrode plate includes a positive electrode current collector and a positive electrode active substance layer, where the positive electrode active substance layer is applied on a surface of the positive electrode current collector. In some embodiments, the positive electrode current collector further has a portion uncoated with the positive electrode active substance layer, where the portion of the positive electrode current collector uncoated with the positive electrode active substance layer protrudes from a portion of the positive electrode current collector coated with the positive electrode active substance layer. The portion of the positive electrode current collector uncoated with the positive electrode active substance layer is used as a positive electrode tab. In some other embodiments, the positive electrode tab may alternatively be a structure that is separated from the positive electrode current collector and electrically connected to the positive electrode current collector. A lithium-ion battery is used as an example, for which, the positive electrode current collector may be made of aluminum, and the positive electrode active substance may be lithium cobalt, lithium iron phosphate, ternary material (for example, NCM), lithium manganese, or the like. The negative electrode plate includes a negative electrode current collector and a negative electrode active substance layer, where the negative electrode active substance layer is applied on a surface of the negative electrode current collector. The portions of the positive electrode plate and the negative electrode plate with active substances constitute the body portion 11 of the electrode assembly 10. In some embodiments, the negative electrode current collector further has a portion uncoated with the negative electrode active substance layer, where the portion of the negative electrode current collector uncoated with the negative electrode active substance layer protrudes from a portion of the negative electrode current collector coated with the negative electrode active substance layer. The portion of the negative electrode current collector uncoated with the negative electrode active substance layer is used as a negative electrode tab. In some other embodiments, the negative electrode tab may alternatively be a structure that is separated from the negative electrode current collector and electrically connected to the negative electrode current collector. The negative electrode current collector may be made of copper, and the negative electrode active substance may be carbon, silicon, or the like. To allow a large current to pass through without any fusing, a plurality of positive electrode tabs are provided and stacked together, and a plurality of negative electrode tabs are provided and stacked together.

The first tab 12 may be a positive electrode tab. In an embodiment where the electrode assembly 10 includes a plurality of positive electrode tabs, the plurality of positive electrode tabs may be stacked and connected to form an integral structure. The plurality of positive electrode tabs may be connected through welding or conductive adhesives. A stacking direction of the plurality of positive electrode tabs may be parallel to a thickness direction of the positive electrode tab and a thickness direction X of the battery cell. The thickness direction of the positive electrode tab is parallel to the thickness direction X of the battery cell.

The first tab 12 may alternatively be a negative electrode tab. In an embodiment where the electrode assembly 10 includes a plurality of negative electrode tabs, the plurality of negative electrode tabs may be stacked and connected to each other. The plurality of negative electrode tabs may be connected through welding or conductive adhesives to form an integral structure. A stacking direction of the plurality of negative electrode tabs may be parallel to a thickness direction of the negative electrode tab and the thickness direction X of the battery cell. The thickness direction of the negative electrode tab is parallel to the thickness direction X of the battery cell.

The separator may be made of PP (polypropylene, polypropylene), PE (polyethylene, polyethylene), or the like. In addition, the electrode assembly 10 may be a wound structure or a laminated structure. In these embodiments, the electrode assembly 10 is a wound structure. A production process of the battery cell 100 includes conventional processes. The production process includes: A positive electrode plate, a negative electrode plate, and a separator are manufactured; the positive electrode plate, the negative electrode plate, and the separator are wound or stacked to form the electrode assembly 10, followed by conventional processes such as packaging, electrolyte injection, formation, and voltage monitoring.

The first tab lead 30 is a conductor, and the first tab lead 30 is connected to the first tab 12. In an embodiment where the electrode assembly 10 includes a plurality of first tabs 12, an integral structure formed by stacking and connecting the plurality of first tabs 12 is connected to the first tab lead 30. A portion of the first tab lead 30 extends to a position between the first packaging film 21 and the second packaging film 22. The first tab 12 has an overlapping portion with the first tab lead 30 between the first packaging film 21 and the second packaging film 22. The first tab 12 and the first tab lead 30 are connected at the overlapping portion to form a first connection portion 40. The first connection portion 40 is accommodated in the second groove 212. The first tab lead 30 may be stacked with the first tab 12 along a thickness direction of the first tab 12, so that the first tab 12 and the first tab lead 30 partially overlap with each other. Another portion of the first tab lead 30 extends out of a position between the first packaging film 21 and the second packaging film 22, and may be configured to be connected to an electric device or another conductive structure.

The first tab lead 30 may be in the form of a linear structure, a sheet-like structure, or the like, which is not limited in this application.

An accommodating space is formed in the packaging bag 20. Through a packaging process, the accommodating space forms an enclosed space, and the electrode assembly 10 is sealed in the accommodating space. The packaging bag 20 may be formed as a soft shell, for example, an aluminum-plastic film, to form a pouch battery cell. A packaging process of the packaging bag 20 includes but is not limited to melting, hot pressing, and provision of a sealing member.

The first packaging film 21 may include an adhesive layer, a metal layer, and a protective layer, where the metal layer is located between the adhesive layer and the protective layer, and the protective layer is located on an outer side of the metal layer. In some embodiments, the adhesive layer is a polypropylene layer serving as a sealing adhesion function during the packaging of the packaging bag 20. The metal layer is an aluminum layer and is used to reduce entry of external moisture and the like and leakage of an internal electrolyte after the packaging of the packaging bag 20. The protective layer is a nylon layer, where the nylon layer has a high melting point and strong mechanical properties, providing protection for the electrode assembly 10 in the packaging bag 20. The structure of the second packaging film 22 may be the same as the structure of the first packaging film 21.

The first packaging film 21 and the second packaging film 22 jointly form the packaging bag 20. Before the formation of the packaging bag 20, the first packaging film 21 and the second packaging film 22 may be two separate portions. The body portion 11 of the electrode assembly 10 is accommodated in the first groove 211, and the first connection portion 40 is accommodated in the second groove 212. Then, the first packaging film 21 and the second packaging film 22 are arranged opposite each other along a thickness direction X of the battery cell, so that the second packaging film 22 covers the first groove 211 and the second groove 212 on the first packaging film 21. Then, the first packaging film 21 and the second packaging film 22 are packaged into an entirety.

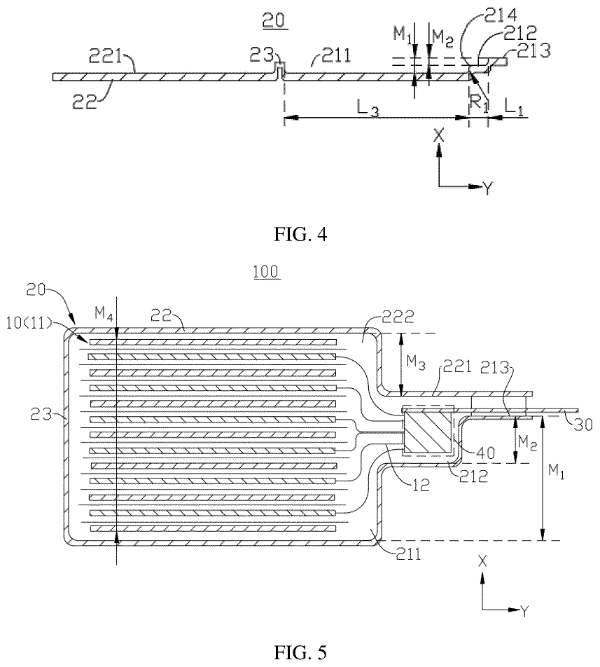

As shown in FIGS. 3 and 4, before the formation of the packaging bag 20, the first packaging film 21 and the second packaging film 22 may alternatively be connected integrally. The first packaging film 21 and the second packaging film 22 are connected to each other through a folding portion 23. The second packaging film 22 may be folded around the folding portion 23, so that the second packaging film 22 and the first packaging film 21 are arranged opposite each other along the thickness direction X of the battery cell. The folding portion may extend along a length direction Y of the battery cell or may extend along a width direction Z of the battery cell. FIGS. 3 and 4 show a case where the folding portion extends along the width direction Z of the battery cell. A folding line of the second packaging film 22 folded relative to the first packaging film 21 extends along the width direction Z of the battery cell. The body portion 11 of the electrode assembly 10 is accommodated in the first groove 211, the first connection portion 40 is accommodated in the second groove 212, and then the second packaging film 22 is folded around the folding portion 23, so that the second packaging film 22 and the first packaging film 21 are arranged opposite each other along the thickness direction X of the battery cell; and the second packaging film 22 covers the first groove 211 and the second groove 212 on the first packaging film 21. Then, unconnected regions of the first packaging film 21 and the second packaging film 22 are connected and packaged into an entirety.

The first connection portion 40 may be entirely located in the second groove 212, or the first connection portion 40 may be partially located in the second groove 212.

Table 1 shows test data of battery cells 100 in some examples and comparative examples in this application. In the table, tests were performed to detect the presence or absence of wrinkles and electrolyte leakage of the packaging bags 20 at top sealing positions of the battery cells 100 listed in the table (a sealing position of a side of the first connection portion 40 facing away from the first groove 211 and a sealing position of a side of a second connection portion 60 facing away from the first groove 211 mentioned below). The presence or absence of wrinkles of the packaging bags 20 could be determined by visually checking the flatness of the packaging bags 20 at the top sealing positions. The presence or absence of electrolyte leakage of the packaging bags 20 could be determined by soaking the battery cells 100 in water at 65° C. for 3 days to observe the presence or absence of inflation, where the presence of inflation indicated electrolyte leakage, while the absence of inflation indicated no electrolyte leakage. In Table 1, for the battery cells 100 in examples and comparative examples, other portions of the battery cells not listed in Table 1 (such as the positive electrodes, the negative electrodes, the separators, the electrolytes, and the like) were the same. The material of the positive electrode plate included NCM523, conductive carbon black (Super P), and polyvinylidene fluoride (PVDF) at a weight ratio of 97.0:1.4:1.6, with a compacted density of 3.4 g/cm³. The material of the negative electrode plate included artificial graphite (Graphite), conductive carbon black (Super P), and styrene-butadiene rubber (SBR) at a weight ratio of 96:1.5:2.5, with a compacted density of 1.6 g/cm³. The separator was polyethylene (PE) with a thickness of 7 μm. The electrolyte was lithium hexafluorophosphate (LiPF₆) with a lithium salt concentration of 1.15 mol/L.

TABLE 1

| | Battery cell | Whether | | Percentage | Percentage of |
|---|---|---|---|---|---|
| | dimension | second | Production | of battery | battery cells |
| | (thickness*width | groove is | quantity | cells with | with electrolyte |
| | *length) | present | (unit) | wrinkles | leakage |
| Comparative | 9.5 mm*110 | No | 20000 | 45.6% | 0.7% |
| example 1 | mm*130 mm | | | | |
| Comparative | 10.5 mm*130 | No | 20000 | 47.2% | 0.9% |
| example 2 | mm*190 mm | | | | |
| Example 1 | 9.5 mm*110 | Yes | 20000 | 0.1% | 0.0% |
| | mm*130 mm | | | | |
| Example 2 | 10.5 mm*110 | Yes | 20000 | 0.0% | 0.0% |
| | mm*130 mm | | | | |
| Example 3 | 11.5 mm*110 | Yes | 20000 | 0.0% | 0.0% |
| | mm*130 mm | | | | |
| Example 4 | 10.5 mm*130 | Yes | 20000 | 0.1% | 0.0% |
| | mm*190 mm | | | | |
| Example 5 | 11.5 mm*130 | Yes | 20000 | 0.0% | 0.0% |
| | mm*190 mm | | | | |
| Example 6 | 12.5 mm*130 | Yes | 20000 | 0.0% | 0.0% |
| | mm*190 mm | | | | |

It can be seen from Table 1 that the packaging bag 20 in each of Examples 1 to 6 almost has no wrinkle at the top sealing position (that is, much lower than that in each of Comparative examples 1 and 2) and almost has no electrolyte leakage. Thus, it can be seen that the second groove 212 provided on the packaging bag 20 in this application significantly improves the packaging reliability of the packaging bag 20.

Therefore, since the second groove 212 is formed on the side of the first packaging film 21 facing the second packaging film 22, and at least a portion of the first connection portion 40 formed by connecting the first tab 12 and the first tab lead 30 is accommodated in the second groove 212, as compared with a case where the second groove 212 is formed during the packaging process, this may reduce the risks of interference between the first connection portion 40 and the first packaging film 21 as well as interference between the first connection portion 40 and the second packaging film 22, reducing the extrusion stress between the first connection portion 40 and the first packaging film 21 as well as the extrusion stress between the first connection portion 40 and the second packaging film 22, thereby alleviating the problem of the first packaging film 21 and the second packaging film 22 being uneven and prone to wrinkling at the top sealing positions due to the extrusion stress during packaging of the battery cell 100, and improving the packaging reliability. As compared with the case where the second groove is formed during the packaging process, the external contour size of the battery cell 100 in this solution may be substantially the same, so the volumetric energy density of the battery cell 100 is not reduced.

It should be noted that the top sealing positions refer to the sealing position of the side of the first connection portion 40 facing away from the first groove 211 and the sealing position of the side of the second connection portion 60 facing away from the first groove 211 mentioned below.

In some embodiments, the first groove 211 and the second groove 212 may be formed in a manner of cutting off a portion of the material on the surface of the first packaging film 21 facing the second packaging film 22, so that the thickness of the region with the material cut is less than the thickness of another position of the first packaging film 21, thereby forming the first groove 211 and the second groove 212.

In some other embodiments, the first groove 211 and the second groove 212 may be formed by punching, where the first groove 211 and the second groove 212 may be formed by punching once or formed by punching twice.

In some embodiments, as shown in FIG. 3, a depth of the second groove 212 is less than a depth of the first groove 211.

A surface of the first packaging film 21 facing the second packaging film 22 is defined as a first surface 213. The first groove 211 and the second groove 212 are both recessed from the first surface 213 along a direction facing away from the second packaging film 22. The depth of the first groove 211 is a dimension of the first groove 211 recessed from the first surface 213 in the direction facing away from the second packaging film 22. The depth of the second groove 212 is a dimension of the second groove 212 recessed from the first surface 213 along the direction facing away from the second packaging film 22. In these embodiments, the first packaging film 21 and the second packaging film 22 are arranged opposite each other in the thickness direction X of the battery cell. Thus, the depth of the first groove 211 may alternatively be understood as a dimension of the first groove 211 in the thickness direction X of the battery cell, and the depth of the second groove 212 may alternatively be understood as a dimension of the second groove 212 in the thickness direction X of the battery cell. The depth of the first groove 211 is M₁, and the depth of the second groove 212 is M₂; where M₁>M₂.

In these embodiments, the first tab 12 is connected to an end of the body portion 11 in the length direction Y of the battery cell. The second groove 212 is provided on a side of the first groove 211 in the length direction Y of the battery cell and is in communication with the first groove 211. The first groove 211 and the second groove 212 are arranged in a stepped manner along the length direction Y of the battery cell. The length direction Y of the battery cell is perpendicular to the thickness direction X of the battery cell. Along the length direction Y of the battery cell, the body portion 11 is entirely located in the first groove 211, and the first tab 12 extends from the body portion 11 to the second groove 212 and is connected to the first tab lead 30 to form the first connection portion 40.

In the depth direction of the first groove 211 and the second groove 212, a dimension of the body portion 11 is greater than a dimension of the first connection portion 40, and the depth of the second groove 212 is less than the depth of the first groove 211. In the depth direction of the second groove 212, a space defined by the second groove 212 and the second packaging film 22 is more compatible with the dimension of the first connection portion 40. This further reduces the risks of interference between the first connection portion 40 and the first packaging film 21 as well as interference between the first connection portion 40 and the second packaging film 22, reducing the risk of the first packaging film 21 and the second packaging film 22 being prone to wrinkling and uneven at positions corresponding to the first connection portion 40 due to the extrusion stress during the packaging of the battery cell 100, thereby effectively alleviating the problem of the packaging bag 20 being prone to wrinkling and uneven during the packaging of the battery cell 100, further improving the packaging reliability.

In an embodiment where the first groove 211 and the second groove 212 are arranged in a stepped manner, a bottom surface of the second groove 212 is connected to a side surface of the first groove 211. The portion of the side surface of the first groove 211 connected to the bottom surface of the second groove 212 is perpendicular to the bottom surface of the second groove 212. The bottom surface of the second groove 212 is a surface of the second groove 212 perpendicular to the recessed direction of the second groove 212 (that is, the thickness direction X of the battery cell). The side surface of the first groove 211 is a surface of the first groove 211 parallel to the recessed direction of the first groove 211 (that is, the thickness direction X of the battery cell).

The bottom surface of the second groove 212 and the side surface of the first groove 211 may be directly connected to each other or indirectly connected to each other. In some embodiments, as shown in FIG. 2, the side surface of the first groove 211 and the bottom surface of the second groove 212 are connected to each other through a first arc surface 214. A radius of the first arc surface 214 is R₁, where 0.3 mm≤R₁≤5 mm.

The side surface of the first groove 211 and the bottom surface of the second groove 212 are indirectly connected to each other through the first arc surface 214. The radius R₁ of the first arc surface 214 may be 0.3 mm, 0.4 mm, 0.6 mm, 0.8 mm, 1 mm, 1.2 mm, 1.5 mm, 1.8 mm, 2 mm, 2.2 mm, 2.5 mm, 2.8 mm, 3 mm, 3.2 mm, 3.5 mm, 3.8 mm, 4 mm, 4.2 mm, 4.5 mm, 4.8 mm, or 5 mm.

The side surface of the first groove 211 and the bottom surface of the second groove 212 are connected to each other through the first arc surface 214, which may reduce the first packaging film 21 from having stress concentration between the side surface of the first groove 211 and the bottom surface of the second groove 212, thereby improving the strength of the first packaging film 21. If the radius R₁ of the first arc surface 214 is less than 0.3 mm, the stress concentration factor of the first packaging film 21 between the side surface of the first groove 211 and the bottom surface of the second groove 212 is not significantly reduced, failing to effectively alleviate the stress concentration problem between the side surface of the first groove 211 and the bottom surface of the second groove 212. If the radius R₁ of the arc surface is greater than 5 mm, a wall thickness at a corresponding position of the first arc surface 214 may be excessively small, thus reducing the structural strength of the first packaging film 21. Therefore, the radius R₁ of the first arc surface 214 satisfying 0.3 mm≤R₁≤5 mm may reduce stress concentration between the side surface of the first groove 211 and the bottom surface of the second groove 212 while ensuring the wall thickness of the first packaging film 21 at the corresponding position of the first arc surface 214 to satisfy the strength requirements of the first packaging film 21.

In some embodiments, along the thickness direction X of the battery cell, a projection of the first connection portion 40 on the first packaging film 21 falls within the second groove 212. In this case, the first connection portion 40 is located in the second groove 212 in any direction perpendicular to the thickness direction X of the battery cell. For example, along the length direction Y of the battery cell, the first connection portion 40 is entirely located in the second groove 212; and along the width direction Z of the battery cell, the first connection portion 40 is entirely located in the second groove 212. The thickness direction X of the battery cell, the length direction Y of the battery cell, and the width direction Z of the battery cell are perpendicular to each other. Along the thickness direction X of the battery cell, the first connection portion 40 may be entirely located in the second groove 212 or extend out of the second groove 212. If the first connection portion 40 is located in the second groove 212 in any direction, the first connection portion 40 is entirely accommodated in the second groove 212. The first connection portion 40 extends out of the second groove 212 in any direction, so that a portion of the first connection portion 40 is accommodated in the second groove 212.

Along the thickness direction X of the battery cell, the projection of the first connection portion 40 on the first packaging film 21 falls within the second groove 212, so that in directions other than the thickness direction X of the battery cell, the first connection portion 40 does not extend out of the second groove 212. This further reduces the risks of interference between the first connection portion 40 and the first packaging film 21 as well as interference between the first connection portion 40 and the second packaging film 22, reducing the risk of the first packaging film 21 and the second packaging film 22 being prone to wrinkling and uneven at positions corresponding to the first connection portion 40 due to the extrusion stress during the packaging of the battery cell 100, thereby effectively alleviating the problem of the packaging bag 20 being prone to wrinkling and uneven during the packaging of the battery cell 100, further improving the packaging reliability.

Still referring to FIGS. 1 and 2, in some embodiments, along the length direction Y of the battery cell, a length of the second groove 212 is L₁, and a length of the first connection portion 40 is L₂; where 0.2 mm≤L₁−L₂≤5 mm.

The length L₁ of the second groove 212 is a dimension of the second groove 212 along the length direction Y of the battery cell, that is, a distance, along the length direction Y of the battery cell, between a side surface of the second groove 212 farthest from the first groove 211 and the side surface of the first groove 211 connected to the bottom surface of the second groove 212. L₂ is a dimension of the first connection portion 40 along the length direction Y of the battery cell.

L₁−L₂ may be 0.2 mm, 0.5 mm, 0.8 mm, 1 mm, 1.2 mm, 1.5 mm, 1.8 mm, 2 mm, 2.2 mm, 2.5 mm, 2.8 mm, 3 mm, 3.2 mm, 3.5 mm, 3.8 mm, 4 mm, 4.2 mm, 4.5 mm, 4.8 mm, or 5 mm.

If L₁−L₂<0.2 mm, along the length direction Y of the battery cell, a margin of the length of the second groove 212 relative to the length of the first connection portion 40 is small, which is not conducive to accommodating the first connection portion 40 in the second groove 212 during the assembly of the battery cell 100. If L₁−L₂>5 mm, a large space in the second groove 212 is wasted, making the first connection portion 40 be prone to shaking in the second groove 212, thus increasing the packaging difficulty of the battery cell 100. Therefore, 0.2 mm≤L₁−L₂≤5 mm allows the length of the second groove 212 to have a reasonable margin relative to the length of the first connection portion 40, is conducive to accommodating the first connection portion 40 in the second groove 212, and may also reduce the space waste, reduce the degree of shaking of the first connection portion 40 in the second groove 212, and reduce the packaging difficulty of the battery cell 100.

As shown in FIG. 2, in some embodiments, along the thickness direction X of the battery cell, a vertical distance from the bottom surface of the second groove 212 to an inner surface of the second packaging film 22 is T₁, and a maximum thickness of the first connection portion 40 is T₂; where 1≤T₁/T₂≤2. In some other embodiments, 1.4≤T₁/T₂≤2.

T₁ is a distance between the bottom surface of the second groove 212 and a surface of the second packaging film 22 opposite to the bottom surface of the second groove 212 along the thickness direction X of the battery cell. T₂ is a maximum dimension of the first connection portion 40 along the thickness direction X of the battery cell.

T₁/T₂ may be 1.1, 1.2, 1.3, 1.4, 1.5, 1.6, 1.7, 1.8, 1.9, or 2.

Table 2 shows wrinkles and electrolyte leakage of the battery cells 100 including the packaging bags 20 with different values of T₁/T₂ during packaging. For the battery cells 100 of Comparative example 2 and Examples 7 to 12, other portions not listed in Table 2 (such as the positive electrodes, the negative electrodes, the separators, the electrolytes, and the like) were the same.

TABLE 2

| | | | | | Percentage of |
|---|---|---|---|---|---|
| | Battery cell | | | | battery cells |
| | dimension | | Production | Percentage of | with |
| | (thickness*width | | quantity | battery cells | electrolyte |
| | *length) | T₁/T₂ | (unit) | with wrinkles | leakage |
| Comparative | 10.5 mm*130 | NA | 20000 | 47.2% | 0.9% |
| example 2 | mm*190 mm | | | | |
| Example 7 | 10.5 mm*130 | 1.0 | 20000 | 0.2% | 0.0% |
| | mm*190 mm | | | | |
| Example 8 | 10.5 mm*130 | 1.2 | 20000 | 0.1% | 0.0% |
| | mm*190 mm | | | | |
| Example 9 | 10.5 mm*130 | 1.4 | 20000 | 0.0% | 0.0% |
| | mm*190 mm | | | | |
| Example 10 | 10.5 mm*130 | 1.6 | 20000 | 0.0% | 0.0% |
| | mm*190 mm | | | | |
| Example 11 | 10.5 mm*130 | 1.8 | 20000 | 0.0% | 0.0% |
| | mm*190 mm | | | | |
| Example 12 | 10.5 mm*130 | 2.0 | 20000 | 0.0% | 0.0% |
| | mm*190 mm | | | | |

It can be seen from Table 2 that when the packaging bag 20 in each of Examples 7 to 12 is provided with the second groove 212 on the first packaging film 21 and T₁/T₂ is 1.0, 1.2, 1.4, 1.6, 1.8, or 2.0, the battery cell 100 almost has no wrinkle and no electrolyte leakage at the top sealing position. As T₁/T₂ increases, the percentage of the battery cells with wrinkles and the percentage of the battery cells with electrolyte leakage decrease.

However, based on the assembly of the battery cell 100 during the actual operation, it can be seen that in a case where T₁/T₂ is less than 1, although the first connection portion 40 almost has no shaking between the first packaging film 21 and the second packaging film 22 after the battery cell 100 is packaged, the first connection portion 40 interferes with the first packaging film 21 and the second packaging film 22, causing difficulty in assembling the battery cell 100. In a case where T₁/T₂ is greater than 1, although neither the first packaging film 21 nor the second packaging film 22 interferes with the first connection portion 40 and the assembly of the battery cell 100 is relatively easy, a large space existing between the first packaging film 21 and the second packaging film 22 allows the first connection portion 40 to shake significantly and easily leads to sealing failure at positions corresponding to the first connection portion 40.

Therefore, 1≤T₁/T₂≤2 allows the percentage of the battery cells with wrinkles and the percentage of the battery cells with electrolyte leakage to decrease during the production process of the battery cell 100, allows the first connection portion 40 to be smoothly accommodated between the first packaging film 21 and the second packaging film 22, and may also alleviate the problem of the first connection portion 40 shaking between the first packaging film 21 and the second packaging film 22 along the thickness direction X of the battery cell.

As shown in FIG. 1, in some embodiments, along the width direction Z of the battery cell, a width of the second groove 212 is W₁, and a width of the first connection portion 40 is W₂; where 0.2 mm≤W₁−W₂≤10 mm.

W₁ is a distance between two opposite side surfaces of the second groove 212 along the width direction Z of the battery cell. W₂ is a dimension of the first connection portion 40 along the width direction Z of the battery cell. W₁−W₂ may be 0.2 mm, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, or 10 mm.

If W₁−W₂<0.2 mm, along the width direction Z of the battery cell, a margin of the width of the second groove 212 relative to the width of the first connection portion 40 is small, which is not conducive to accommodating the first connection portion 40 in the second groove 212 during the assembly of the battery cell 100. If W₁−W₂>10 mm, a large space in the second groove 212 is wasted, making the first connection portion 40 be prone to shaking in the second groove 212, thus increasing the packaging difficulty of the battery cell 100. Therefore, 0.2 mm≤W₁−W₂≤10 mm allows the width of the second groove 212 to have a reasonable margin relative to the width of the first connection portion 40, is conducive to accommodating the first connection portion 40 in the second groove 212, and may also reduce the space waste, reduce the degree of shaking of the first connection portion 40 in the second groove 212, and reduce the packaging difficulty of the battery cell 100.

The dimension of the first groove 211 should also match the dimension of the body portion 11 to facilitate the placement of the body portion 11 and reduce space waste in the packaging bag 20.

As shown in FIGS. 1 and 2, in some embodiments, along the length direction Y of the battery cell, a length of the first groove 211 is L₃, and a length of the body portion 11 is L₄; where 0.2 mm≤L₃−L₄≤10 mm.

L₃ is a dimension of the first groove 211 along the length direction Y of the battery cell, that is, a distance, along the length direction Y of the battery cell, between a side surface of the first groove 211 farthest from the second groove 212 and the side surface of the first groove 211 connected to the bottom surface of the second groove 212. L₄ is a dimension of the body portion 11 along the length direction Y of the battery cell.

L₃−L₄ may be 0.2 mm, 0.5 mm, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, or 10 mm.

If L₃−L₄<0.2 mm, along the length direction Y of the battery cell, a margin of the length of the first groove 211 relative to the length of the body portion 11 is small, which is not conducive to accommodating the body portion 11 in the first groove 211 during the assembly of the battery cell 100. If L₃−L₄>10 mm, a large space in the first groove 211 is wasted, making the body portion 11 be prone to shaking in the first groove 211. Therefore, 0.2 mm≤L₃−L₄≤10 mm allows the length of the first groove 211 to have a reasonable margin relative to the length of the body portion 11, is conducive to accommodating the body portion 11 in the first groove 211, and may also reduce the space waste and reduce the degree of shaking of the body portion 11 in the first groove 211.

Still referring to FIG. 1, in some embodiments, along the width direction Z of the battery cell, a width of the first groove 211 is W₃, and a width of the body portion 11 is W₄; where 0.2 mm≤W₃−W₄≤3 mm.

W₃ is a distance between two opposite side surfaces of the first groove 211 along the width direction Z of the battery cell. The width W₃ of the first groove 211 may be the same as the width W₁ of the second groove 212. Certainly, the width W₃ of the first groove 211 and the width W₁ of the second groove 212 may alternatively be adaptively adjusted based on the width W₄ of the body portion 11 and the width W₂ of the first connection portion 40. For example, the width W₂ of the first connection portion 40 is less than the width W₄ of the body portion 11, so that the width W₁ of the second groove 212 may be less than the width W₃ of the first groove 211, allowing the width W₃ of the first groove 211 and the width W₁ of the second groove 212 to be different.

W₄ is a dimension of the body portion 11 along the width direction Z of the battery cell. W₃−W₄ may be 0.2 mm, 0.5 mm, 0.8 mm, 1 mm, 1.2 mm, 1.5 mm, 1.8 mm, 2 mm, 2.2 mm, 2.5 mm, 2.8 mm, or 3 mm.

If W₃−W₄<0.2 mm, along the width direction Z of the battery cell, a margin of the width of the first groove 211 relative to the width of the body portion 11 is small, which is not conducive to accommodating the body portion 11 in the first groove 211 during the assembly of the battery cell 100. If L₁−L₂>3 mm, a large space in the first groove 211 is wasted, making the body portion 11 be prone to shaking in the first groove 211 along the width direction Z of the battery cell. Therefore, 0.2 mm≤W₃−W₄≤3 mm allows the width of the first groove 211 to have a reasonable margin relative to the width of the body portion 11, is conducive to accommodating the body portion 11 in the second groove 212, and may also reduce the space waste and reduce the degree of shaking of the body portion 11 in the first groove 211 along the width direction Z of the battery cell.

The second packaging film 22 may have many structures. As shown in FIGS. 2 to 4, in some embodiments, a side of the second packaging film 22 facing the first packaging film 21 may be a plane.

A surface of the second packaging film 22 facing the first packaging film 21 is defined as a second surface 221, where the second surface 221 is a plane. Along the thickness direction X of the battery cell, a distance between the surface of the second packaging film 22 facing the first packaging film 21 and the bottom surface of the first groove 211 is greater than a distance between the surface of the second packaging film 22 facing the first packaging film 21 and the bottom surface of the second groove 212. It can be understood that along the thickness direction X of the battery cell, a distance between the second surface 221 and the bottom surface of the first groove 211 is greater than a distance between the second surface 221 and the bottom surface of the second groove 212. In this way, the first packaging film 21 and the second packaging film 22 may jointly define two spaces matching dimensions of the body portion 11 and the first connection portion 40 in the thickness direction X of the battery cell.

The surface of the second packaging film 22 facing the first packaging film 21 is a plane, allowing the structure of the second packaging film 22 to be simple, thereby facilitating the manufacturing and formation of the packaging bag 20.

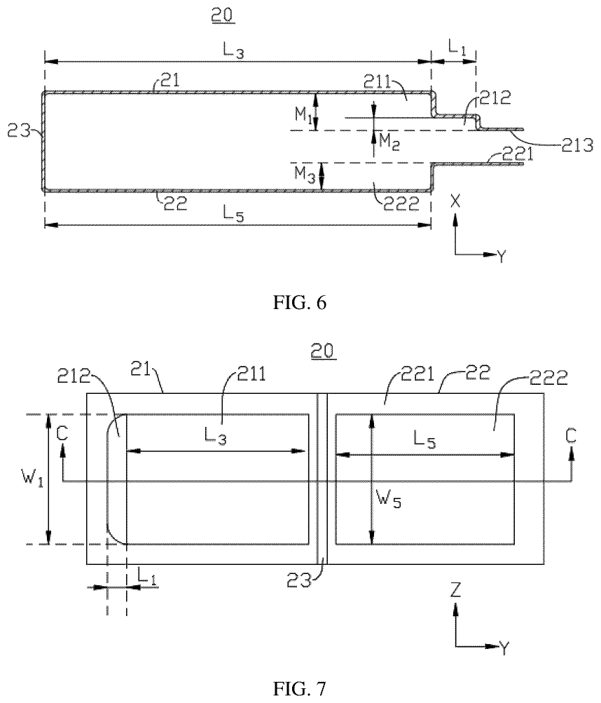

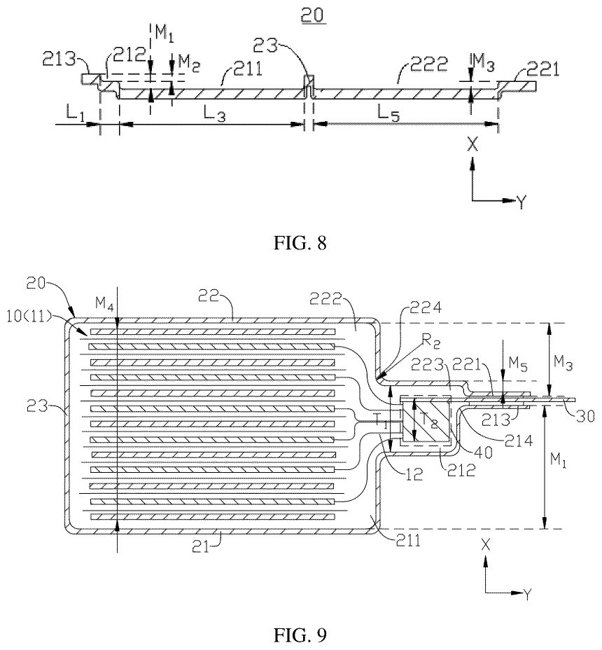

In some other embodiments, as shown in FIGS. 5 to 8, a third groove 222 is formed on the side of the second packaging film 22 facing the first packaging film 21; the third groove 222 is opposite to the first groove 211; and the body portion 11 is accommodated in a space enclosed by the first groove 211 and the third groove 222.

The surface of the second packaging film 22 facing the first packaging film 21 is defined as the second surface 221. The third groove 222 is recessed from the second surface 221 in a direction facing away from the first packaging film 21. A depth of the third groove 222 is a dimension of the third groove 222 recessed from the second surface 221 in the direction facing away from the first packaging film 21. The depth of the third groove 222 is M₃. The depth M₃ of the third groove 222 may be the same as or different from the depth M₁ of the first groove 211.

Along the length direction Y of the battery cell, a length of the third groove 222 is L₅. L₅ is a dimension of the third groove 222 along the length direction Y of the battery cell, that is, a distance, along the length direction Y of the battery cell, between two opposite side surfaces of the third groove 222. Along the length direction Y of the battery cell, the length L₅ of the third groove 222 may be the same as the length L₃ of the first groove 211.

Along the width direction Z of the battery cell, a width of the third groove 222 is W₅. W₅ is a dimension of the third groove 222 along the width direction Z of the battery cell, that is, a distance, along the width direction Z of the battery cell, between the two opposite side surfaces of the third groove 222. Along the width direction Z of the battery cell, the width W₅ of the third groove 222 may be the same as the width W₃ of the first groove 211. Certainly, along the width direction Z of the battery cell, the width W₅ of the third groove 222 may be the same as the width W₃ of the first groove 211.

The first groove 211 and the third groove 222 are opposite each other in the thickness direction X of the battery cell. Along the thickness direction X of the battery cell, a portion of the body portion 11 is accommodated in the first groove 211, and a portion of the body portion 11 is accommodated in the third groove 222.

The third groove 222 may be formed in a manner of cutting off a portion of the material on the surface of the second packaging film 22 facing the first packaging film 21, so that the thickness of the region with the material cut is less than the thickness of another position of the second packaging film 22, thereby forming the third groove 222. The third groove 222 may alternatively be formed by punching.

The third groove 222 opposite to the first groove 211 is formed on the surface of the second packaging film 22 facing the first packaging film 21. The first groove 211 and the second groove 212 jointly enclose a space for accommodating the body portion 11, so that the space for accommodating the body portion 11 is distributed to the first packaging film 21 and the second packaging film 22. As compared with a case where the first groove 211 is only formed on the first packaging film 21, the first groove 211 is formed on the first packaging film 21 and the third groove 222 is formed on the second packaging film 22, making the depth of each groove for accommodating the body portion 11 be smaller, thereby making the formation difficulty of the packaging bag 20 be lower.

In an embodiment where the third groove 222 is provided on the surface of the second packaging film 22 facing the first packaging film 21, along the thickness direction X of the battery cell, a depth of the first groove 211 is M₁, a depth of the third groove 222 is M₃, and a thickness of the body portion 11 is M₄; where 1≤(M₁+M₃)/M₄≤1.3.

The thickness M₄ of the body portion 11 is a dimension of the body portion 11 along the thickness direction X of the battery cell.

(M₁+M₃)/M₄ may be 1, 1.02, 1.05, 1.08, 1.1, 1.12, 1.15, 1.18, 1.2, 1.22, 1.25, 1.28, or 1.3.

If (M₁+M₃)/M₄<1, along the thickness direction X of the battery cell, a space between a bottom surface of the first groove 211 and a bottom surface of the third groove 222 may be less than the thickness of the body portion 11, causing the body portion 11 to interfere with the first packaging film 21 and the second packaging film 22, and making it difficult to accommodate the body portion 11 between the first packaging film 21 and the second packaging film 22. If (M₁+M₃)/M₄>1.3, the space between the bottom surface of the first groove 211 and the bottom surface of the third groove is excessively large relative to the thickness of the body portion 11, making the body portion 11 be prone to shaking between the first packaging film 21 and the second packaging film 22 along the thickness direction X of the battery cell. Therefore, 1≤(M₁+M₃)/M₄≤1.3 may make the body portion 11 be smoothly accommodated between the first packaging film 21 and the second packaging film 22, and may also reduce the degree of shaking of the body portion 11 between the first packaging film 21 and the second packaging film 22 along the thickness direction X of the battery cell.

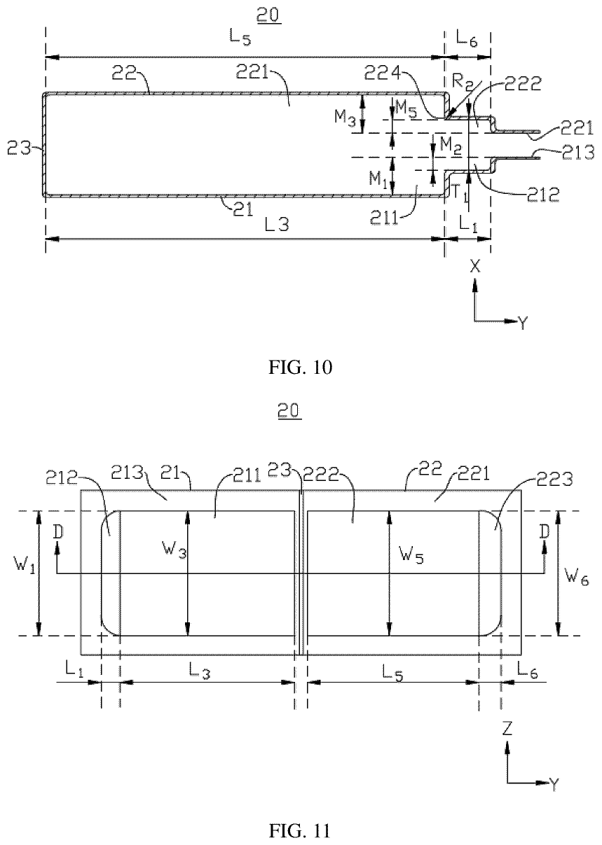

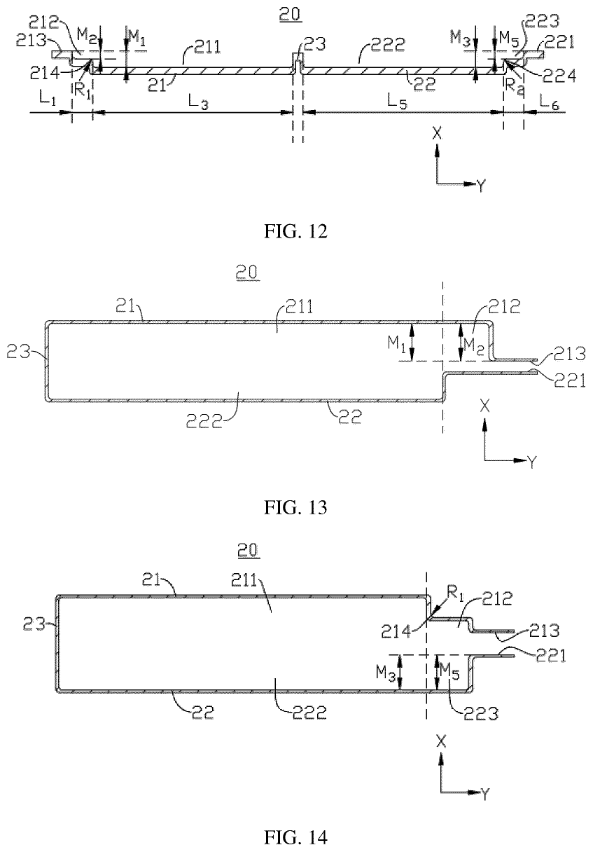

In some embodiments, as shown in FIGS. 9 to 12, a fourth groove 223 is further formed on the side of the second packaging film 22 facing the first packaging film 21; the fourth groove 223 is opposite to the second groove 212; at least a portion of the first connection portion 40 is accommodated in a space enclosed by the second groove 212 and the fourth groove 223; and a depth of the fourth groove 223 is less than a depth of the third groove 222.

The fourth groove 223 is recessed from the second surface 221 in a direction facing away from the first packaging film 21. The depth of the fourth groove 223 is a dimension of the fourth groove 223 recessed from the second surface 221 in the direction facing away from the first packaging film 21. The depth of the fourth groove 223 is M₅. The depth M₅ of the fourth groove 223 may be the same as or different from the depth M₂ of the second groove 212.

In these embodiments, the fourth groove 223 is provided on a side of the third groove 222 along the length direction Y of the battery cell and is in communication with the fourth groove 223. The fourth groove 223 and the third groove 222 are arranged in a stepped manner along the length direction Y of the battery cell.

The fourth groove 223 may be formed in a manner of cutting off a portion of the material on the surface of the second packaging film 22 facing the first packaging film 21, so that the thickness of the region with the material cut is less than the thickness of another position of the second packaging film 22 except the position corresponding to the third groove 222, thereby forming the fourth groove 223. The fourth groove 223 may alternatively be formed by punching. In an embodiment where the second packaging film 22 is provided with the third groove 222 and the fourth groove 223, the third groove 222 and the fourth groove 223 may be formed by punching once or punching twice.

A bottom surface of the fourth groove 223 is connected to a side surface of the third groove 222. The portion of the side surface of the third groove 222 connected to the bottom surface of the fourth groove 223 is perpendicular to the bottom surface of the fourth groove 223. The bottom surface of the fourth groove 223 is a surface of the fourth groove 223 perpendicular to the recessed direction of the fourth groove 223 (that is, the thickness direction X of the battery cell). The side surface of the third groove 222 is a surface of the third groove 222 parallel to the recessed direction of the third groove 222 (that is, the thickness direction X of the battery cell).

The bottom surface of the fourth groove 223 and the side surface of the third groove 222 may be directly connected to each other or indirectly connected to each other. In some embodiments, the side surface of the third groove 222 and the bottom surface of the fourth groove 223 are connected to each other through a second arc surface 224. A radius of the second arc surface 224 is R₂, and the radius R₂ of the second arc surface 224 may be the same as or different from the radius R₁ of the first arc surface 214.

Along the length direction Y of the battery cell, a length of the fourth groove 223 is L₆. L₆ is a dimension of the fourth groove 223 along the length direction Y of the battery cell, that is, a distance, along the length direction Y of the battery cell, between a side surface of the fourth groove 223 farthest from the side surface of the third groove 222 and the side surface of the third groove 222 connected to the bottom surface of the fourth groove 223. Along the length direction Y of the battery cell, the length L₆ of the fourth groove 223 may be the same as or different from the length L₁ of the second groove 212.

Along the width direction Z of the battery cell, a width of the fourth groove 223 is W₆. W₆ is a dimension of the fourth groove 223 along the width direction Z of the battery cell, that is, a distance, along the width direction Z of the battery cell, between two opposite side surfaces of the fourth groove 223. Along the width direction Z of the battery cell, the width W₆ of the fourth groove 223 may be the same as or different from the width W₁ of the second groove 212. The length L₆ of the fourth groove 223 and the width W₆ of the fourth groove 223 may be the same as the length L₁ of the second groove 212 and the width W₁ of the second groove 212, respectively.

In an embodiment where the second packaging film 22 is provided with the fourth groove 223, a vertical distance T₁ from the bottom surface of the second groove 212 to the inner surface of the second packaging film 22 is a distance, along the thickness direction X of the battery cell, between the bottom surface of the second groove 212 and the bottom surface of the fourth groove 223.

The fourth groove 223 opposite to the second groove 212 is formed on the surface of the second packaging film 22 facing the first packaging film 21. The second groove 212 and the fourth groove 223 jointly enclose a space for accommodating the first connection portion 40, so that the space for accommodating the first connection portion 40 is distributed to the first packaging film 21 and the second packaging film 22. As compared with a case where the second groove 212 is only formed on the first packaging film 21, the second groove 212 is formed on the first packaging film 21 and the fourth groove 223 is formed on the second packaging film 22, making the depth of each groove for accommodating the first connection portion 40 be smaller, thereby making the formation difficulty of the packaging bag 20 be lower.

In some embodiments, along the thickness direction X of the battery cell, a depth of the second groove 212 is M₂, a depth of the fourth groove 223 is M₅, and a maximum thickness of the first connection portion 40 is T₂; where 1≤(M₂+M₅)/T₂≤2. In some other embodiments, 1.4≤(M₂+M₅)/T₂≤2.

(M₂+M₅)/T₂ may be 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, or 2.

Table 3 shows wrinkles and electrolyte leakage of the battery cells 100 including the packaging bags 20 with different values of (M₂+M₅)/T₂ during packaging. For the battery cells 100 of Comparative example 2 and Examples 13 to 18, other portions not listed in Table 2 (such as the positive electrodes, the negative electrodes, the separators, the electrolytes, and the like) were the same.

TABLE 3

| | Battery cell | | | | |
|---|---|---|---|---|---|
| | dimension | | | Percentage of | Percentage of |
| | (thickness*width | | Production | battery cells | battery cells with |
| | *length) | (M₂ + M₅)/T₂ | quantity (unit) | with wrinkles | electrolyte leakage |
| Comparative | 10.5 mm*130 | \ | 20000 | 47.2% | 0.9% |
| example 2 | mm*190 mm | | | | |
| Example 13 | 10.5 mm*130 | 1.0 | 20000 | 0.1% | 0.0% |
| | mm*190 mm | | | | |
| Example 14 | 10.5 mm*130 | 1.2 | 20000 | 0.1% | 0.0% |
| | mm*190 mm | | | | |
| Example 15 | 10.5 mm*130 | 1.4 | 20000 | 0.0% | 0.0% |
| | mm*190 mm | | | | |
| Example 16 | 10.5 mm*130 | 1.6 | 20000 | 0.0% | 0.0% |
| | mm*190 mm | | | | |
| Example 17 | 10.5 mm*130 | 1.8 | 20000 | 0.0% | 0.0% |
| | mm*190 mm | | | | |
| Example 18 | 10.5 mm*130 | 2.0 | 20000 | 0.0% | 0.0% |
| | mm*190 mm | | | | |

It can be seen from Table 3 that when the packaging bag 20 in each of Examples 13 to 18 is provided with the second groove 212 on the first packaging film 21 and the fourth groove 223 on the second packaging film 22, and (M₂+M₅)/T₂ is 1, 1.2, 1.4, 1.6, 1.8, or 2.0, the battery cell 100 almost has no wrinkle and no electrolyte leakage at the top sealing position. As (M₂+M₅)/T₂ increases, the percentage of the battery cells with wrinkles and the percentage of the battery cells with electrolyte leakage decrease.

However, based on the assembly of the battery cell 100 during the actual operation, it can be seen that in a case where (M₂+M₅)/T₂ is less than 1, although the first connection portion 40 almost has no shaking between the first packaging film 21 and the second packaging film 22 after the battery cell 100 is packaged, the first connection portion 40 interferes with the first packaging film 21 and the second packaging film 22, causing difficulty in assembling the battery cell 100. In a case where (M₂+M₅)/T₂ is greater than 1, although neither the first packaging film 21 nor the second packaging film 22 interferes with the first connection portion 40 and the assembly of the battery cell 100 is relatively easy, a large space existing between the first packaging film 21 and the second packaging film 22 allows the first connection portion 40 to shake significantly and easily leads to sealing failure at positions corresponding to the first connection portion 40.

Therefore, 1≤(M₂+M₅)/T₂≤2 allows the percentage of the battery cells with wrinkles and the percentage of the battery cells with electrolyte leakage to decrease during the production process of the battery cell 100, allows the body portion 11 to be smoothly accommodated between the first packaging film 21 and the second packaging film 22, and may also alleviate the problem of the body portion 11 shaking between the first packaging film 21 and the second packaging film 22 along the thickness direction X of the battery cell.

In some embodiments, the depth of the second groove 212 may be the same as the depth of the first groove 211. In this case, the bottom surface of the first groove 211 and the bottom surface of the second groove 212 are coplanar. As shown in FIG. 14, in an embodiment where the third groove 222 is only provided on the surface of the second packaging film 22 facing the first packaging film 21, a region, overlapping with the third groove 222, of a groove body formed by the first groove 211 and the second groove 212 is considered as the first groove 211. Along the length direction Y of the battery cell, A region, beyond a side of the third groove 222, of the groove body formed by the first groove 211 and the second groove 212 may be considered as the second groove 212. The second groove 212 and the second surface 221 are arranged opposite each other, so that a dimension of a space defined by the first groove 211 and the third groove 222 in the thickness direction X of the battery cell is greater than a dimension of a space defined by the second groove 212 and the second surface 221 in the thickness direction X of the battery cell. It should be noted that a vertical dashed line in FIG. 14 is shown for convenience in distinguishing between the first groove 211 and the second groove 212 and does not limit the structure of the packaging bag 20.

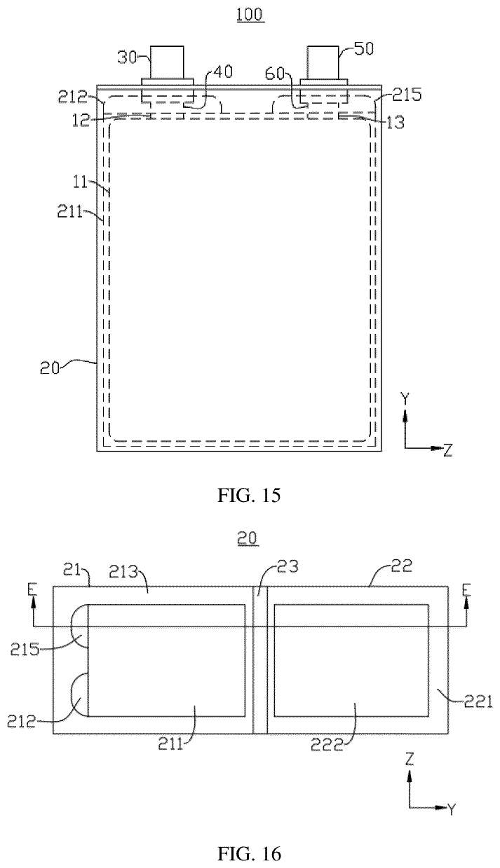

In an embodiment where the depth of the first groove 211 is greater than the depth of the second groove 212, as shown in FIG. 14, the depths of the third groove 222 and the fourth groove 223 provided on the second packaging film 22 may be the same, and the bottom surface of the third groove 222 and the bottom surface of the fourth groove 223 are coplanar. Along the length direction Y of the battery cell, a sum of the lengths of the third groove 222 and the fourth groove 223 is the same as a sum of the lengths of the first groove 211 and the second groove 212. A region, overlapping with the first groove 211, of an entirety formed by the third groove 222 and the fourth groove 223 may be considered as the third groove 222. A region, overlapping with the second groove 212, of an entirety formed by the third groove 222 and the fourth groove 223 may be considered as the fourth groove 223. A dimension of a space defined by the first groove 211 and the third groove 222 in the thickness direction X of the battery cell is greater than a dimension of a space defined by the second groove 212 and the fourth groove 223 in the thickness direction X of the battery cell. It should be noted that a vertical dashed line in FIG. 15 is shown for convenience in distinguishing between the third groove 222 and the fourth groove 223 and does not limit the structure of the packaging bag 20.

As shown in FIG. 1, in some embodiments, the electrode assembly 10 further includes a second tab 13. The second tab 13 and the first tab 12 have opposite polarities. An end of the second tab 13 is connected to the body portion 11. The battery cell 100 further includes a second tab lead 50, where an end of the second tab lead 50 is connected to another end of the second tab 13 to form a second connection portion 60, and another end of the second tab lead 50 extends out of the packaging bag 20 from between the first packaging film 21 and the second packaging film 22. At least a portion of the second connection portion 60 is accommodated in the second groove 212.

The second tab 13 and the first tab 12 have opposite polarities. It can be understood that if the first tab 12 is a positive electrode tab, the second tab 13 is a negative electrode tab; or if the first tab 12 is a negative electrode tab, the second tab 13 is a positive electrode tab.

If the second tab 13 is a positive electrode tab, in an embodiment where the electrode assembly 10 includes a plurality of second tabs 13, the plurality of second tabs 13 may be stacked and connected to form an integral structure. The plurality of second tabs 13 may be connected through welding or conductive adhesives. A stacking direction of the plurality of second tabs 13 may be parallel to a thickness direction of the second tab 13 and the thickness direction X of the battery cell. The thickness direction of the second tab 13 is parallel to the thickness direction X of the battery cell.

The second tab lead 50 is a conductor, and the second tab lead 50 is connected to the second tab 13. In an embodiment where the electrode assembly 10 includes a plurality of second tabs 13, the integral structure formed by stacking and connecting the plurality of second tabs 13 is connected to the second tab lead 50. A portion of the second tab lead 50 extends to a position between the first packaging film 21 and the second packaging film 22. The second tab 13 has an overlapping portion with the second tab lead 50 between the first packaging film 21 and the second packaging film 22. The second tab 13 and the second tab lead 50 are connected at the overlapping portion to form the second connection portion 60. The second tab lead 50 may be stacked with the second tab 13 along the thickness direction of the second tab 13, so that the second tab 13 and the second tab lead 50 partially overlap with each other. Another portion of the second tab lead 50 extends out of a position between the first packaging film 21 and the second packaging film 22, and may be configured to be connected to an electric device or another conductive structure.

The second connection portion 60 may be partially accommodated in the second groove 212, or the second connection portion 60 may be entirely accommodated in the second groove 212.

The second tab 13 and the first tab 12 may be connected to a same end of the body portion 11 along the length direction Y of the battery cell. The first tab lead 30 and the second tab lead 50 both extend out of the packaging bag from a same end of the packaging bag along the length direction Y of the battery cell. The first connection portion 40 and the second connection portion 60 are both at least partially accommodated in the second groove 212. A first accommodating portion and a second accommodating portion are spaced apart in the second groove 212 along the width direction Z of the battery cell.

Along the width direction Z of the battery cell, a sum of the width of the first connection portion 40 and the width of the second connection portion 60 should be less than the width of the second groove 212.

At least a portion of the second connection portion 60 formed by connecting the second tab 13 and the second tab lead 50 is accommodated in the second groove 212. This may reduce the risks of interference between the second connection portion 60 and the first packaging film 21 as well as interference between the second connection portion 60 and the second packaging film 22, reducing the risk of the first packaging film 21 and the second packaging film 22 being uneven at positions corresponding to the second connection portion 60 due to the stress during the packaging of the battery cell 100, thereby effectively alleviating the problem of the packaging bag 20 having wrinkles during the packaging of the battery cell 100, improving the packaging reliability, and causing no reduction of the energy density of the battery cell 100. The second connection portion 60 and the first connection portion 40 are both accommodated in the second groove 212, resulting in fewer grooves on the packaging bag 20, allowing the structure of the packaging bag 20 to be simpler, thereby facilitating the manufacturing and formation of the packaging bag 20.

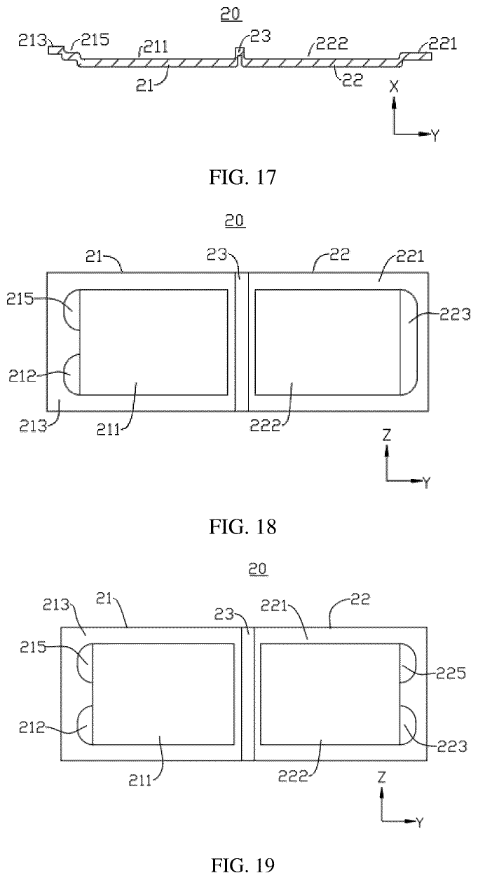

In some other embodiments, the second connection portion 60 and the first connection portion 40 may be respectively accommodated in different grooves. As shown in FIGS. 15 to 19, the electrode assembly 10 further includes a second tab 13. The second tab 13 and the first tab 12 have opposite polarities. An end of the second tab 13 is connected to the body portion 11. The battery cell 100 further includes a second tab lead 50, where an end of the second tab lead 50 is connected to another end of the second tab 13 to form a second connection portion 60, and another end of the second tab lead 50 extends out of the packaging bag 20 from between the first packaging film 21 and the second packaging film 22. A fifth groove 215 is further formed on the side of the first packaging film 21 facing the second packaging film 22; at least a portion of the second connection portion 60 is accommodated in the fifth groove 215; and a depth of the fifth groove 215 is less than the depth of the first groove 211.

The second tab 13 is connected to an end of the body portion 11 in the length direction Y of the battery cell. The fifth groove 215 is provided on a side of the first groove 211 in the length direction Y of the battery cell and is in communication with the first groove 211. The first groove 211 and the fifth groove 215 are arranged in a stepped manner along the length direction Y of the battery cell. The length direction Y of the battery cell is perpendicular to the thickness direction X of the battery cell. Along the length direction Y of the battery cell, the body portion 11 is entirely located in the first groove 211, and the second tab 13 extends from the body portion 11 to the fifth groove 215 and is connected to the second tab lead 50 to form the second connection portion 60.

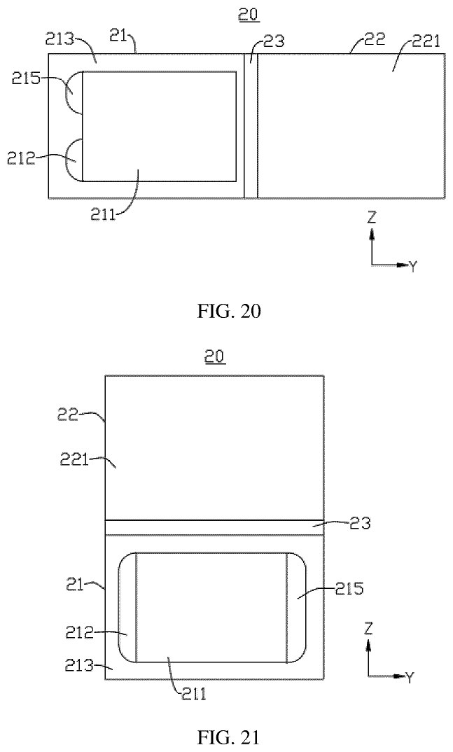

In this case, as shown in FIGS. 15 and 16, the first tab 12 and the second tab 13 may be connected to a same end of the body portion 11 along the length direction Y of the battery cell. Thus, the fifth groove 215 and the second groove 212 are both located on a same side of the first groove 211 along the length direction Y of the battery cell, and the fifth groove 215 and the second groove 212 are spaced apart along the width direction Z of the battery cell. In an embodiment where the second groove 212 and the fifth groove 215 are both located on the same side of the first groove 211 along the length direction Y of the battery cell, as shown in FIG. 16, the surface of the second packaging film 22 facing the first packaging film 21 is provided with only the third groove 222 with the same length as the first groove 211; or as shown in FIG. 18, the surface of the second packaging film 22 facing the first packaging film 21 is provided with the third groove 222 with the same length as the first groove 211 and the fourth groove 223 with the same length as the second groove 212. Along the width direction Z of the battery cell, the width of the fourth groove 223 is not less than a distance between an end of the second groove 212 facing away from the fifth groove 215 and an end of the fifth groove 215 facing away from the second groove 212. In this way, after the first packaging film 21 and the second packaging film 22 are arranged opposite each other along the thickness direction X of the battery cell, projections of the second groove 212 and the fifth groove 215 on the second packaging film 22 are both located in the fourth groove 223. The first connection portion 40 is accommodated in a space enclosed by the second groove 212 and the fourth groove 223, and the second connection portion 60 is accommodated in a space enclosed by the fifth groove 215 and the fourth groove 223. Alternatively, as shown in FIG. 19, the surface of the second packaging film 22 facing the first packaging film 21 is provided with the third groove 222, the fourth groove 223, and the sixth groove 225. The sixth groove 225 and the fourth groove 223 are located on a same side of the third groove 222 along the length direction Y of the battery cell. The sixth groove 225 and the fourth groove 223 are spaced apart along the width direction Z of the battery cell. The sixth groove 225 and the third groove 222 are arranged in a stepped manner along the length direction Y of the battery cell. After the first packaging film 21 and the second packaging film 22 are arranged opposite each other in the thickness direction X of the battery cell, along the thickness direction X of the battery cell, the fourth groove 223 and the second groove 212 are arranged opposite each other. The first connection portion 40 is accommodated in the space enclosed by the second groove 212 and the fourth groove 223. The fifth groove 215 and the sixth groove 225 are arranged opposite each other. The second connection portion 60 is accommodated in a space enclosed by the fifth groove 215 and the sixth groove 225. Alternatively, as shown in FIG. 20, the surface of the second packaging film 22 facing the first packaging film 21 may be a plane.

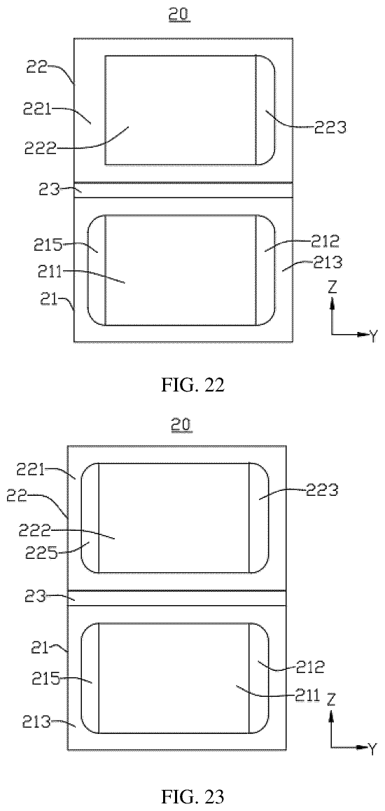

The first tab 12 and the second tab 13 may alternatively be connected to two ends of the body portion 11 along the length direction Y of the battery cell. In this way, as shown in FIGS. 21 to 23, the fifth groove 215 and the second groove 212 are respectively located on two sides of the first groove 211 along the length direction Y of the battery cell. The first connection portion 40 and the second connection portion 60 are respectively accommodated in the second groove 212 and the fifth groove 215. In an embodiment where the fifth groove 215 and the second groove 212 are respectively located on two sides of the first groove 211 along the length direction Y of the battery cell, as shown in FIG. 21, the surface of the second packaging film 22 facing the first packaging film 21 (the second surface 221) may be a plane; or as shown in FIG. 22, the second packaging film facing the surface of the first packaging film 21 (the second surface 221) is provided with the third groove 222 and the fourth groove 223. Along the length direction Y of the battery cell, the length of the third groove 222 is the same as the length of the first groove 211. The fourth groove 223 is provided at an end of the third groove 222 along the length direction Y of the battery cell and arranged with the third groove 222 in a stepped manner. After the first packaging film 21 and the second packaging film 22 are arranged opposite each other in the thickness direction X of the battery cell, the fourth groove 223 and the second groove 212 are arranged opposite each other. The first connection portion 40 is accommodated in the space enclosed by the fourth groove 223 and the second groove 212. The fifth groove 215 and the second surface 221 are arranged opposite each other. The second connection portion 60 is accommodated in a space enclosed by the fifth groove 215 and the second surface 221. Alternatively, as shown in FIG. 22, the surface of the second packaging film 22 facing the first packaging film 21 (the second surface 221) is provided with the third groove 222, the fourth groove 223, and the sixth groove 225. The sixth groove 225 and the fourth groove 223 are located on two sides of the third groove 222 along the length direction Y of the battery cell. The fourth groove 223 and the third groove 222 are arranged in a stepped manner along the length direction Y of the battery cell. The sixth groove 225 and the third groove 222 are arranged in a stepped manner along the length direction Y of the battery cell. After the first packaging film 21 and the second packaging film 22 are arranged opposite each other in the thickness direction X of the battery cell, along the thickness direction X of the battery cell, the fourth groove 223 and the second groove 212 are arranged opposite each other. The first connection portion 40 is accommodated in the space enclosed by the second groove 212 and the fourth groove 223. The fifth groove 215 and the sixth groove 225 are arranged opposite each other. The second connection portion 60 is accommodated in the space enclosed by the fifth groove 215 and the sixth groove 225.

At least a portion of the second connection portion 60 formed by connecting the second tab 13 and the second tab lead 50 is accommodated in the fifth groove 215. This may reduce the risks of interference between the second connection portion 60 and the first packaging film 21 as well as interference between the second connection portion 60 and the second packaging film 22, reducing the risk of the first packaging film 21 and the second packaging film 22 being uneven at positions corresponding to the second connection portion 60 due to the stress during the packaging of the battery cell 100, thereby effectively alleviating the problem of the packaging bag 20 having wrinkles during the packaging of the battery cell 100, improving the packaging reliability, and causing no reduction of the energy density of the battery cell 100. The second connection portion 60 and the first connection portion 40 are respectively accommodated in the fifth groove 215 and the second groove 212, which may reduce the risks of short circuits in the battery cell 100 and facilitate the independent packaging of the battery cell 100 at positions corresponding to the first connection portion 40 and the second connection portion 60.

Some embodiments of this application further provide a secondary battery. The secondary battery includes the battery cell 100 according to any one of the foregoing embodiments.

A battery module or a battery pack may include a plurality of battery cells 100 described above, where the plurality of battery cells 100 are connected in series, parallel, or series-parallel. Being connected in series-parallel means a combination of series and parallel connections of the plurality of battery cells 100.

The battery cell 100 provided in the above embodiments has a lower possibility of the packaging bag 20 having wrinkles during the packaging process, so that the packaging reliability is improved. Therefore, the secondary battery including the battery cell 100 has high packaging reliability, thereby allowing the secondary battery to have good safety performance.

Some embodiments of this application further provide an electric device, where the electric device includes the secondary battery provided in the above embodiments.

The secondary battery provides electrical energy for the electric device to perform functions. The electric device may include one or more secondary batteries.

The electric device may be but is not limited to a mobile phone, a tablet computer, a notebook computer, an electric drill, an electric saw, an electric vehicle, an electric motorcycle, an electric bicycle, or the like.

The secondary battery provided in the above embodiments has good safety performance and may improve the electric safety of the electric device.

The foregoing embodiments are merely preferred embodiments of this application which are not intended to limit this application. Persons skilled in the art understand that this application may have various modifications and variations. Any modification, equivalent replacement, and improvement made without departing from the spirit and principle of this application shall fall within the protection scope of this application.

What is claimed is:

1. A battery cell, comprising:
an electrode assembly comprising a body portion and a first tab, wherein an end of the first tab is connected to the body portion;
a packaging bag comprising a first packaging film and a second packaging film, wherein the electrode assembly is disposed between the first packaging film and the second packaging film; and
a first tab lead, wherein an end of the first tab lead is connected to another end of the first tab to form a first connection portion, and another end of the first tab lead extends out of the packaging bag from between the first packaging film and the second packaging film;
wherein a first groove and a second groove are formed on a side of the first packaging film facing the second packaging film; at least a portion of the body portion is accommodated in the first groove; and at least a portion of the first connection portion is accommodated in the second groove.

2. The battery cell according to claim 1, wherein along a thickness direction of the battery cell, a depth of the second groove is less than a depth of the first groove.

3. The battery cell according to claim 1, wherein a side surface of the first groove and a bottom surface of the second groove are connected to each other through a first arc surface; and a radius of the first arc surface is R₁, 0.3 mm≤R₁≤5 mm.

4. The battery cell according to claim 1, wherein along a thickness direction of the battery cell, a projection of the first connection portion on the first packaging film falls within the second groove.

5. The battery cell according to claim 1, wherein along a length direction of the battery cell, a length of the second groove is L₁, and a length of the first connection portion is L₂, 0.2 mm≤L₁−L₂≤5 mm.

6. The battery cell according to claim 1, wherein along a thickness direction of the battery cell, a vertical distance from a bottom surface of the second groove to an inner surface of the second packaging film is T₁, and a maximum thickness of the first connection portion is T₂, 1≤T₁/T₂≤2.

7. The battery cell according to claim 1, wherein along a width direction of the battery cell, a width of the second groove is W₁, and a width of the first connection portion is W₂, 0.2 mm≤W₁−W₂≤10 mm.

8. The battery cell according to claim 1, wherein along a length direction of the battery cell, a length of the first groove is L₃, and a length of the body portion is L₄, 0.2 mm≤L₃−L₄≤10 mm; and/or
along a width direction of the battery cell, a width of the first groove is W₃, and a width of a body portion is W₄, 0.2 mm≤W₃−W₄≤3 mm.

9. The battery cell according to claim 1, wherein a side of the second packaging film facing the first packaging film is a plane.

10. The battery cell according to claim 1, wherein a third groove is formed on a side of the second packaging film facing the first packaging film, the third groove is opposite to the first groove; and the body portion is accommodated in a space enclosed by the first groove and the third groove.

11. The battery cell according to claim 10, wherein along a thickness direction of the battery cell, a depth of the first groove is M₁, a depth of the third groove is M₃, and a thickness of the body portion is M₄, 1≤(M₁+M₃)/M₄≤1.3.

12. The battery cell according to claim 10, wherein a fourth groove is further formed on the side of the second packaging film facing the first packaging film, the fourth groove is opposite to the second groove; at least a portion of the first connection portion is accommodated in a space enclosed by the second groove and the fourth groove; and along a thickness direction of the battery cell, a depth of the fourth groove is less than a depth of the third groove.

13. The battery cell according to claim 12, wherein along the thickness direction of the battery cell, a depth of the second groove is M₂, the depth of the fourth groove is M₅, and a maximum thickness of the first connection portion is T₂, 1≤(M₂+M₅)/T₂≤2.

14. The battery cell according to claim 1, wherein the electrode assembly further comprises a second tab, the second tab and the first tab have opposite polarities, and an end of the second tab is connected to the body portion; and
the battery cell further comprises a second tab lead, an end of the second tab lead is connected to another end of the second tab to form a second connection portion, and another end of the second tab lead extends out of the packaging bag from between the first packaging film and the second packaging film;
wherein at least a portion of the second connection portion is accommodated in the second groove.

15. The battery cell according to claim 1, wherein the electrode assembly further comprises a second tab, the second tab and the first tab have opposite polarities, and an end of the second tab is connected to the body portion; and
the battery cell further comprises a second tab lead, an end of the second tab lead is connected to another end of the second tab to form a second connection portion, and another end of the second tab lead extends out of the packaging bag from between the first packaging film and the second packaging film;
wherein a fifth groove is further formed on the side of the first packaging film facing the second packaging film; at least a portion of the second connection portion is accommodated in the fifth groove; and a depth of the fifth groove is less than the depth of the first groove.

16. A secondary battery, comprising a battery cell, the battery cell comprising:
an electrode assembly comprising a body portion and a first tab, wherein an end of the first tab is connected to the body portion;
a packaging bag comprising a first packaging film and a second packaging film, wherein the electrode assembly is disposed between the first packaging film and the second packaging film; and
a first tab lead, wherein an end of the first tab lead is connected to another end of the first tab to form a first connection portion, and another end of the first tab lead extends out of the packaging bag from between the first packaging film and the second packaging film;
wherein a first groove and a second groove are formed on a side of the first packaging film facing the second packaging film; at least a portion of the body portion is accommodated in the first groove; and at least a portion of the first connection portion is accommodated in the second groove.

17. The secondary battery according to claim 16, wherein along a thickness direction of the battery cell, a depth of the second groove is less than a depth of the first groove.

18. The secondary battery according to claim 16, wherein a side surface of the first groove and a bottom surface of the second groove are connected to each other through a first arc surface; and a radius of the first arc surface is R₁, 0.3 mm≤R₁≤5 mm.

19. The secondary battery according to claim 16, wherein along a thickness direction of the battery cell, a projection of the first connection portion on the first packaging film falls within the second groove.

20. An electric device, comprising a secondary battery, the secondary battery comprising a battery cell, the battery cell comprising:
an electrode assembly comprising a body portion and a first tab, wherein an end of the first tab is connected to the body portion;
a packaging bag comprising a first packaging film and a second packaging film, wherein the electrode assembly is disposed between the first packaging film and the second packaging film; and
a first tab lead, wherein an end of the first tab lead is connected to another end of the first tab to form a first connection portion, and another end of the first tab lead extends out of the packaging bag from between the first packaging film and the second packaging film;
wherein a first groove and a second groove are formed on a side of the first packaging film facing the second packaging film; at least a portion of the body portion is accommodated in the first groove; and at least a portion of the first connection portion is accommodated in the second groove.
